(19) United States
(12) Patent Application Publication
(10) Pub. No.: US 2007/0097504 A1
(43) Pub. Date: May 3, 2007

(54) DUAL PANEL DISPLAY

(76) Inventors: Rui-Yong Li, Tao-Yuan Hsien (TW); Chuan-Pei Yu, I-Lan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/279,111

(22) Filed: Apr. 10, 2006

(30) Foreign Application Priority Data
Oct. 28, 2005 (TW) 094137844

(51) Int. Cl. G02B 5/30

(52) U.S. Cl. 359/494; 345/32

(57) ABSTRACT

A dual panel display has a backlight module, a first display panel, a second display panel, and a plurality of reflective polarizers deposited between the first light-exit surface and the first display panel or the second light exit surface and the second display panel of the light guide plate in the backlight module.

### BACKGROUND OF THE INVENTION

1. Field of the Invention

The present invention relates to a structure of a dual-display LCD, and more particularly, to a structure of a dual-display LCD to prevent a non-uniform brightness distribution on the main display panel.

2. Description of the Prior Art

An LCD is a thin and electricity-saving flat display, which uses liquid crystal rotation angle and a polarized light layer to control light transmittance. Brightness is controlled by the transmittance. When color is constant, a liquid crystal remains in a steady state, and this is why the LCD has stable appearance without flicker. Because of the above-mentioned advantages, LCDs are applied in mobile phones, PDAs, notebook computers, and digital cameras. Recently, dual-display LCDs have been applied to various products.

For example, many shell-type mobile phones use dual-display LCDs. The dual-display LCD has a main display panel and a sub-display panel. The sub-display panel emits light from a rear cover of the mobile phone, shows simple words or images, and typically communicates basic call information to users before they answer the phone. The main display panel positioned in the mobile phone shows the main output of the phone.

One prior art dual-display LCD is made by combining two LCD modules back to back. This method increases the weight and thickness of the end product, and therefore does not allow for light, thin, and small products. Another prior art lets light exit on both sides of a backlight module. When assembling a main panel and a sub panel, they are fixed on two sides of a main housing for positioning the panels. The backlight module is positioned between the main housing and the main panel, and it provides light for the sub panel via the main housing. Since a light guide plate is shared between the main panel and the sub panel, there is another problem. Some light enters the sub panel via a light-exiting opening, and other light is reflected to the main panel completely by the white main housing because the sizes of the sub panel and the light-exiting opening are smaller than the main panel. Therefore there is a non-uniform distribution of light on the main panel, i.e., light at the light-exiting opening of the main housing is dim and forms a shadow on the light-exiting opening. This causes a difference of light intensity and color on the main panel.

There are some methods to improve the problems mentioned above. For example, it is possible to modify the pattern of the light guide plate in the backlight module to make the light distribution more uniform, but there is a high threshold in the critical dimension of the pattern design because some light is absorbed in the rear optical source. There is still a non-uniform brightness distribution on the main panel even after fine tuning. Using diffusers can improve this phenomenon, but the result is not good enough. Using composite films like brightness enhancement films or diffusers to overcome this phenomenon substantially increases the cost and thickness of the dual-display LCD. Therefore, the present invention teaches a method of overcome the non-uniform brightness distribution phenomenon, reducing cost, and enhancing quality.

### SUMMARY OF THE INVENTION

The present invention relates to a dual panel display that adjusts light-exiting capacity on both sides of the backlight module and prevents the problem mentioned above.

The claims of the present invention discloses a dual panel display comprising a backlight module, a first display panel, a second display panel, and plurality of reflective polarizers. The backlight module comprises a light guide plate having a light-incidence face, a first light-exit face, and a second light-exit face, the first light-exit face and the second light-exit face positioned parallel with each other and adjacent to the light-incidence face, and at least a light source being positioned at the light-incidence face for producing natural light passing into the light guide plate. A first display panel is positioned at a side of the first light-exit face of the light guide plate, and a second display panel is positioned at a side of the second light-exit face of the light guide plate. Of the plurality of reflective polarizers, at least two of the first reflective polarizers are simultaneously positioned between the first light-exit face of the light guide plate and the first display panel, or between the second light-exit face of the light guide plate and the second display panel.

Since the dual display structure of the present invention uses the plurality of reflective polarizers positioned between the light guide plate of the backlight module and the first display panel or the second display panel, light can be controlled by rotating the included angle of the transmission axis of the reflective polarizers to provide uniform light on the first display panel and overcome the non-uniform brightness distribution phenomenon.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are diagrams of a dual panel display according to the present invention.

FIG. 3 is an exploded diagram of a dual panel display according to the present invention.

FIG. 4 is a three-dimensional diagram of two reflective polarizers shown in FIG. 3.

FIG. 5 and FIG. 6 are respectively diagrams of second and third embodiments of a dual panel display according to the present invention.

### DETAILED DESCRIPTION

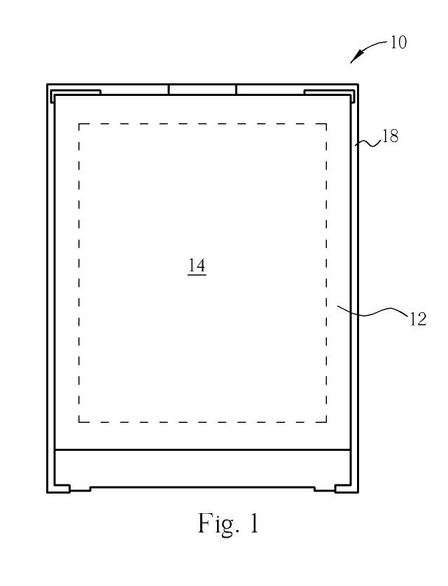

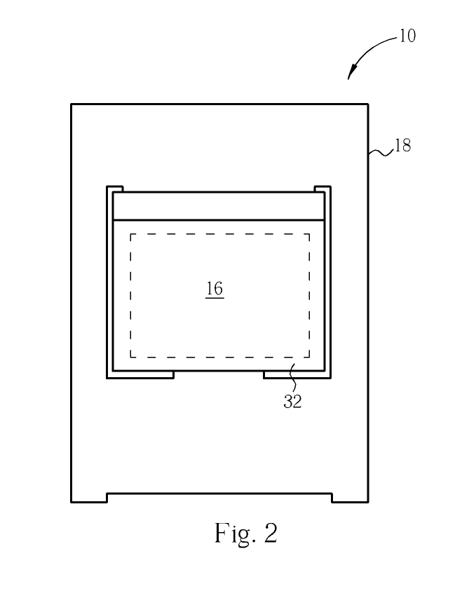

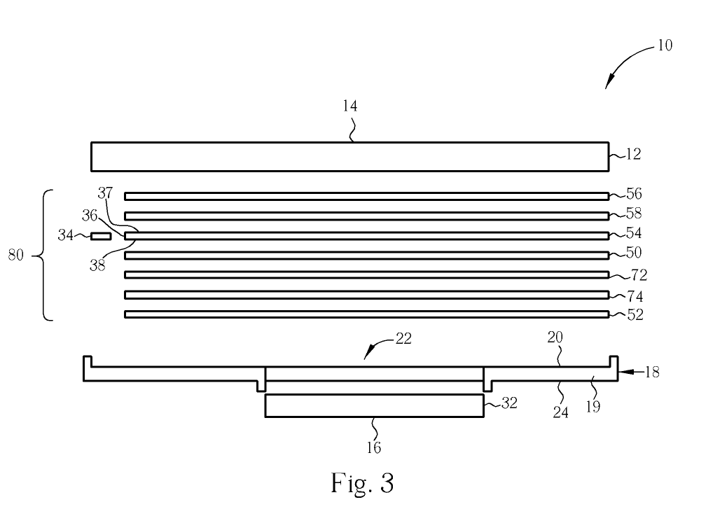

Please refer to FIGS. 1 and 2. FIG. 1 is a front-view diagram of a dual panel display 10 according to the present invention, and FIG. 2 is a rear-view diagram of a dual panel display 10. FIG. 3 is an exploded diagram of a dual panel display 10. As shown in FIG. 1, the dual panel display 10 of the present invention comprises a first display panel 12 which is an LCD panel, and the first display panel 12 comprises a first surface 14 which is the display face of the first display panel 12. A dashed-line area in FIG. 1 is the display area of the first display panel 12. The dual display structure 10 of the present invention also comprises a housing 18 which is used to hold and steady the backlight module 80 shown in FIG. 3 and the first display panel 12. FIG. 2 shows a reverse side of the dual display structure 10 in FIG. 1. As shown in FIG. 2, the dual display structure 10 of the present invention further comprises a second display panel 32 which is an LCD panel, and the second display panel 32 comprises a second surface 16 which is the display face of the second display panel 32. A dashed-line area in FIG. 2 is the display area of the second display panel 32.

As shown in FIG. 1, the dual panel display 10 comprises a first display panel 12, a brightness enhancement film 56, a diffuser 58, a light guide plate 54, a diffuser 50, two reflective polarizers 72, 74, a brightness enhancement film 52, a housing 18, and a second display panel 32. The size of the first display panel 12 is bigger than the second display panel 32 since the first display panel 12 is the main display panel and the second display panel 32 is the sub-display panel. The backlight module 80 comprises a light source 34, the diffusers 50, 58, the brightness enhancement films 52, 56, the light guide plate 54, and the reflective polarizers 72, 74. The light source 34 comprises at least a light generator such as light emitting diode (LED). The light guide plate 54 is of plastic and has a light-entering surface 36, and two parallel surfaces adjacent to the light-entering surface 36 are defined as a first light-exiting surface 37 and a second light-exiting surface 38. The light source 34 is positioned at side of the light-entering surface 36 to generate light to enter into the light guide plate 54. The diffuser 58 and the brightness enhancement films 56 are positioned between the first light-exiting surface 37 and the first display panel 12. Furthermore, in order to provide better backlight for the second display panel 32, the diffuser 50 and the brightness enhancement films 52 are positioned between the second light-exiting surface 38 and the housing 18 in sequence in the dual panel display 10. The reflective polarizers 72, 74 are positioned between the light guide plate 54 and the brightness enhancement films 52. The housing 18 has a fixing surface 19 with a light-exiting opening 22, and there are one first fixing surface 20 and one second fixing surface 24 on both sides of fixing base 19 of the housing 18. The first display panel 12 is positioned on the first fixing surface 20 of the housing 18. The backlight module 80 and the reflective polarizers 72, 74 are positioned between the first display panel 12 and the first fixing surface 20. The second display panel 32 is positioned on the second fixing surface 24 of the housing 18. The size of the light-exiting opening 22 is approximately the same as the size of the second display panel 32.

When light is emitted from the light source 34, it comes into the light guide plate 54 through the light-entering surface 36 first. Then, part of the light travels to one side near the first display panel 12 and spreads uniformly on the first display panel 12 by way of the diffuser 58 and the brightness enhancement films 56. In the meantime, another part of the light travels to another side of the light guide plate 54 through the diffuser 50 and the brightness enhancement films 52 to the fixing base 19, and the light nearby light-exiting opening 22 enters the second display panel 32 via the light-exiting opening 22 of the housing 18 and spreads uniformly on the second display panel 32 to result in dual-panel display. In the prior art, light traveling to the fixing base 19 is completely reflected to the first display panel 12 by the first fixing surface 20 of the white housing 18. However, the light nearby the light-exiting opening 22 directly passes through the light-exiting opening 22 and enters the second display panel 32. Therefore, light nearby the light-exiting opening 22 will not be reflected by the first fixing surface 20 of the white housing 18 to the first display panel 12 and will spread out in a non-uniform distribution of light on the first display panel 12. This results in a shadow having a shape near the light-exiting opening 22 on the first display panel 12 and is known as the non-uniform brightness distribution phenomenon. The non-uniform brightness distribution phenomenon can also arise from poor design of the light guide plate 54.

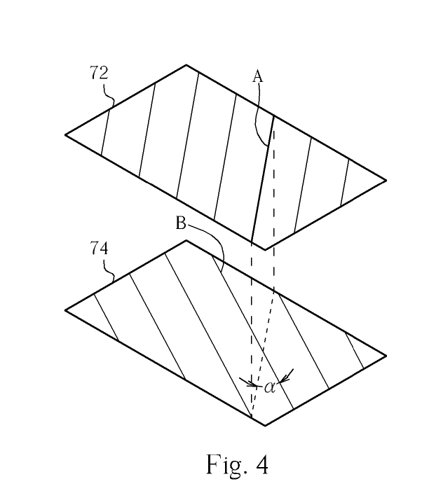

However, the reflective polarizers 72, 74 are positioned at the side of the second light-exiting surface 38 of the light guide plate 54, so the light intensity through the light guide plate 54 to the fixing surface 19 can be adjusted, and part of light emitted from the second light-exiting surface 38 is reflected to the light guide plate 54 increasing brightness on the first light-exiting surface 37 in order to overcome the non-uniform brightness distribution phenomenon on the first display panel 12. Please refer FIG. 4. FIG. 4 is a three-dimensional diagram of the reflective polarizers 72, 74 shown in FIG. 3. The reflective polarizers 72, 74 are added between the second display panel 32 and the second light-exiting surface 38 of the light guide plate 54 in the present invention, and two transmission axes A, B of the adjacent reflective polarizers 72, 74 have an included angle defined as a comparative angle of the two reflective polarizers. According to Malus's Law:
I=I₀ cos^{2 α} (1)

(I₀: incident light intensity, I: transmission light intensity, α: comparative angle)

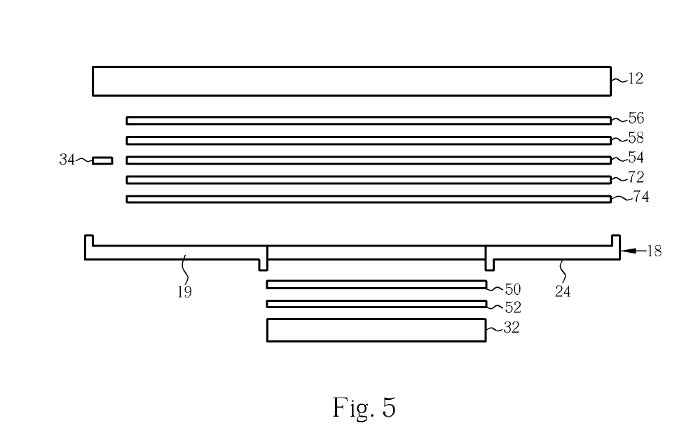

The coupling polarization character of the adjacent reflective polarizers 72, 74 can be changed by adjusting the comparative angle of the two reflective polarizers. The light intensity of one side of the adjacent reflective polarizers 72, 74 can be different from the light intensity of the other side. For example, the comparative angle of the two reflective polarizers 72, 74 can be adjusted to reflect more light emitting from the second light-exiting surface 38 back to the light guide plate 54 in order to increase the light intensity on the first light-exiting surface 37. The light emitting from the light guide plate 54 and entering into the fixing surface 19 becomes less, and therefore the brightness of the light-exiting opening 22 on the second display panel 32 is relatively lower. The light reflected from the light guide plate 54 travels through the diffuser 58 and the brightness enhancement films 56 to provide uniform brightness on the first display panel 12 and overcome the non-uniform brightness distribution phenomenon effectively. In another embodiment, the comparative angle of the transmission axes A, B of the adjacent reflective polarizers 72, 74 is less than or equal to 80 degrees and more than or equal to 0 degrees, as shown in FIG. 4. Furthermore, the adjacent reflective polarizers 72, 74 can also be positioned on the fixing surface 19 as shown in FIG. 5, and the diffuser 50 and the brightness enhancement films 52 can be positioned between the light-exiting opening 22 and the second display panel 32.

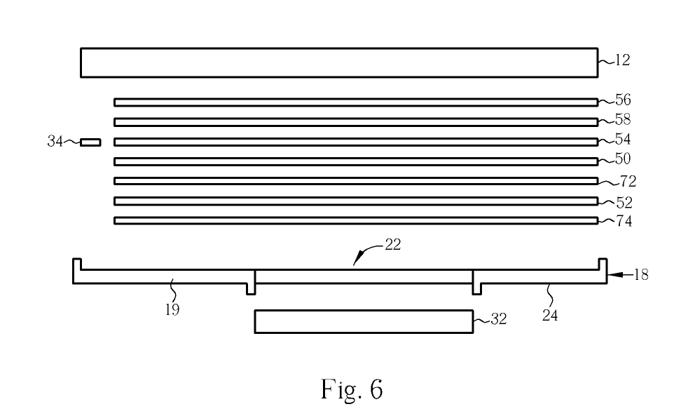

As shown in FIG. 6, in another embodiment, the diffuser 50 and the brightness enhancement films 52 can be positioned between the adjacent reflective polarizers 72, 74. Moreover, the reflective polarizers 72, 74 can be positioned between the first display panel 12 and the first light-exiting surface 37 of the light guide plate 54 to overcome the non-uniform brightness distribution phenomenon on the first display panel 12.

The structure disclosed by the present invention is a dual panel display 10, and therefore when the structure is assembled, miscellaneous optical components must be set up between the first display panel 12 and the second display panel 32 in order to transmit light to the display surfaces of the first display panel 12 and the second display panel 32, i.e., the first surface 14 and the second surface 16. Since the design details of the miscellaneous optical components are not critical to the present invention, they will not be discussed further.

Furthermore, the reflective polarizers 72, 74 are not limited to be adjacent. For example, other optical films such as diffusers can be positioned between the reflective polarizers 72, 74. The comparative angle of the transmission axes A, B of the adjacent reflective polarizers 72, 74 is the only concern to provide better light intensity for the first display panel 12 and the second display panel 32. Moreover, more than two reflective polarizers can be used in the dual panel display 10, and the light intensity in two panels of the dual panel display 10 still can be controlled with Malus's Law. The light guide plate can be positioned between the reflective polarizers.

Compared to the dual display structure of the prior art, the reflective polarizers 72, 74 are included between the second display panel 32 and the second light-exiting surface 38 in the dual panel display according to the present invention, and two transmission axes A, B of the adjacent reflective polarizers 72, 74 have an included angle defined as a comparative angle of the two reflective polarizers. The light intensity of one side of the adjacent reflective polarizers 72, 74 can be different from the light intensity of the other side by adjusting the comparative angle, and light emitted from the light-exiting opening 22 is reduced to overcome the non-uniform brightness distribution phenomenon on the first display panel 12 effectively. Therefore, the present invention can adjust the brightness of the first display panel and the second display panel and overcome non-uniform brightness distribution phenomenon by using two reflective polarizers only. The developing time of the light guide plate is reduced effectively, and redundant films, such as brightness enhancement films and diffusers, can be removed to economize cost and reduce thickness of the dual panel display. The process yield can be improved by collocation of the pattern of the light guide plate. Furthermore, the light intensity can be controlled by adjusting the comparative angle of the plurality of reflective polarizers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dual panel display comprising:
a backlight module comprising:
a light guide plate having a light-incidence face, a first light-exit face, and a second light-exit face, the first light-exit face and the second light-exit face positioned parallel with each other and adjacent to the light-incidence face; and
at least a light source positioned at the light-incidence face for producing natural light to pass into the light guide plate;
a first display panel positioned at a side of the first light-exit face of the light guide plate;
a second display panel positioned at a side of the second light-exit face of the light guide plate; and
a plurality of reflective polarizers, at least two of the first reflective polarizers being simultaneously positioned between the first light-exit face of the light guide plate and the first display panel, or between the second light-exit face of the light guide plate and the second display panel.

2. The dual panel display of claim 1, wherein the dual panel display further comprises a housing having a fixing base for containing the first display panel and the second display panel on a first surface of the fixing base and on a second surface of the fixing base respectively, the fixing base comprising an opening with a size approximately the same as the size of the second display panel.

3. The dual panel display of claim 2, wherein the reflective polarizers are positioned between the first surface of the fixing base and the light guide plate.

4. The dual panel display of claim 1 comprising at least three of the reflective polarizers, wherein one of the reflective polarizers is positioned at the side of the first light-exit face of the light guide plate, and the other two of the reflective polarizers are positioned at the side of the second light-exit face of the light guide plate.

5. The dual panel display of claim 1 comprising at least three of the reflective polarizers, wherein one of the reflective polarizers is positioned at the side of the second light-exit face of the light guide plate, and the other two of the reflective polarizers are positioned at the side of the first light-exit face of the light guide plate.

6. The dual panel display of claim 1, wherein the size of the second display panel is smaller than the size of the first display panel.

7. The dual panel display of claim 1, wherein the backlight module further comprises at least an optical thin film positioned between the transflective polarizers and the light guide plate, between the two transflective polarizers, or at a side of the reflective polarizers opposite the light guide plate.

8. The dual panel display of claim 7, wherein the optical thin film is selected from a group consisting of a diffuser sheet and a brightness enhancement film.

9. The dual panel display of claim 1, wherein each of the reflective polarizers separates natural light into two kinds of linearly polarized light by allowing linearly polarized light parallel to the transmission axis of the reflective polarizer to pass but reflecting or refracting linearly polarized light perpendicular to the transmission axis of the reflective polarizer.

10. The dual panel display of claim 1, wherein the transmission axes of the reflective polarizers have an included angle defined as a comparative angle of the reflective polarizers, the comparative angle enables light exiting from the side of the reflective polarizers near the first display panel to be brighter than light exiting from the side of the reflective polarizers near the second display panel.

11. The dual panel display of claim 10, wherein the comparative angle is less than or equal to 80 degrees and more than or equal to 0 degrees.

12. A method for fabricating a dual panel display, the method comprising:
providing a light guide plate, the light guide plate having a light-incidence face, a first light-exit face, and a second light-exit face, the first and second light-exit faces being parallel with each other and adjacent to the light-incidence face;
positioning at least a light source at the light-incidence face of the light guide plate for generating natural light into the light guide plate and propagating out from the first light-exit face and the second light-exit face;
providing a first display panel positioned at a side of the first light-exit face of the light guide plate;
providing a second display panel positioned at a side of the second light-exit face of the light guide plate; and
providing a plurality of reflective polarizers at one side of the light guide plate.

13. The method of claim 12, wherein the reflective polarizers are positioned between the light guide plate and the first display panel or between the light guide plate and the second display panel.

14. The method of claim 12, wherein some of the reflective polarizers are positioned at a side of the first light-exit face of the light guide plate, and some of the reflective polarizers are positioned at a side of the second light-exit face of the light guide plate.

15. The method of claim 12, wherein the transmission axes of any two adjacent reflective polarizers have an included angle defined as a comparative angle of the two reflective polarizers, and the comparative angle is less than or equal to 80 degrees and more than or equal to 0 degrees.

16. The method of claim 15 further comprising adjusting the degree of the comparative angle enabling light exiting from a side of the two adjacent reflective polarizers to become brighter and light exiting from another side of the two adjacent reflective polarizers to become less bright.

17. The method of claim 12 further comprising providing a housing disposed between the second display panel and the reflective polarizers for positioning the reflective polarizers, the light guide plate, the first display panel and the second display panel.

18. The method of claim 17, wherein the housing comprising a fixing face having an opening, the size of the opening being approximately equal to the size of the second display panel.

19. The method of claim 18, wherein the reflective polarizers are adhered to the fixing base.

20. The method of claim 12 further comprising providing at least an optical film positioning between the light guide plate and the reflective polarizers, between any two adjacent reflective polarizers, or at a side of the reflective polarizer opposite the light guide plate.

21. The method of claim 20, wherein the optical film is selected from a group consisting of a diffusion film and a brightness enhancement film.

22. The method of claim 12, wherein the light guide plate comprises plastic material.

23. The method of claim 12, wherein each of the reflective polarizers is capable of separating natural light into two kinds of linearly polarized lights by allowing linearly polarized light parallel to the transmission axis of the reflective polarizer to pass but reflecting or refracting linearly polarized light perpendicular to the transmission axis of the reflective polarizer.

24. The method of claim 12, wherein the size of the second display panel is smaller than the size of the first display panel.
